(19) United States
(12) Patent Application Publication
(10) Pub. No.: US 2014/0346867 A1
(43) Pub. Date: Nov. 27, 2014

(54) HOME APPLIANCE COMPRISING AN ELECTRIC MOTOR HAVING AT LEAST TWO COILS, METHOD AND SYSTEM FOR CONTROLLING THE HOME APPLIANCE, USE OF ELECTRIC MOTOR FOR FEEDING IN THE HOME APPLIANCE

(71) Applicants: Silvia Helena Pini, Joinville SC (BR); Marcelo Zanelato, Joinville SC (BR); Marcos Roberto de Souza, Santa Luzia (BR)

(72) Inventors: Silvia Helena Pini, Joinville SC (BR); Marcelo Zanelato, Joinville SC (BR); Marcos Roberto de Souza, Santa Luzia (BR)

(73) Assignee: WHIRLPOOL S.A., Sao Paulo, SP (BR)

(21) Appl. No.: 14/343,298

(22) PCT Filed: Sep. 6, 2012
(86) PCT No.: PCT/BR2012/000336

§ 371 Date: Jun. 23, 2014

(30) Foreign Application Priority Data
Sep. 6, 2011 (BR) PI1106205-3

(51) Int. Cl. H02J 3/00; H02P 4/00

(52) U.S. Cl. CPC H02J 3/005; H02P 4/00
USPC 307/17; 318/770

(57) ABSTRACT

A control method and system for home appliances which include an electric motor having at least two coils. The coils of the electric motor are combined in series or in parallel due to the input voltage and are used as a voltage supply for devices of a set of electrical loads which are simultaneously connected to the electric motor. Additionally, an electric motor having at least two coils is used for feeding devices of a set of electrical loads of a home appliance in which one of the coils of the electric motor is used as voltage supply for feeding the devices of the set of electrical loads. Also described are a home appliance which includes a control system, a control method and the use of an electric motor for feeding according to these specifications.

This invention refers to a home appliance which has an electric motor having at least two coils, a method and system for controlling input voltages for loads by means of the electric motor's coils and the use of electric motor for feeding devices of the home appliance. Preferably, the electric motor is an induction motor used in compressors of refrigerators, freezers, air-conditioners or washing machines.

### BACKGROUND OF THE INVENTION

Currently, several countries are different when it comes to producing and distributing electric power, with different voltage levels in each country. Therefore, most electronic devices, such as computers, televisions, radios, among others, have a dual voltage feature comprising an automatic voltage control which enables the adjustment of several input voltages for perfect performance at specific voltages. This feature is still little known in the field of home appliances, once most of them needs electric motors to operate, limited by the current techniques due to factors such as power and control, among others.

In this regard, the few products of this kind which allow for performance at dual voltage are manually switched by the final user who turns a key, which generally modifies the organization of coils in the loads for operation thereof. However, few users have specific knowledge for these tasks, which often results in functional mistakes, causing devices to get burnt or lose part of their functionality, generating drawbacks and risks to these users, depending on the device's protection level.

In order to avoid these drawbacks and to increase protection to users, as well as to avoid unnecessary contacts requiring warranty services, thus reducing losses in the image related to the product's manufacturer; automatic changes in input voltages for an acceptable level for the device's operation become mandatory practices.

Likewise, single-phase induction motors are widely used in refrigerators due to their simplicity, stiffness and high performance. They are applied to several home appliances such as refrigerators, freezers, air-conditioners, washing machines, among others. Induction motors generally have a cage rotor and a stator with coils, generally comprised by two windings used selectively for the state in which the induction motor is found (startup or gear).

In this regard, during the compressor's normal operation, a gear winding is fed by an alternating current, whereas a startup winding is only fed during the first moments of the motor's performance, once the beginning of the startup movement needs more force to the rotor's acceleration. Therefore, motors are designed and built specifically for operation within certain limited voltage ranges, typically with possible variations not higher than 10% above or below what was projected. If these variations exceed 10%, a new project and construction of the motor will be necessary.

In view of this, possible attempts of solving this problem emerge in documents that conceive dual voltage systems. North-American document U.S. Pat. No. 4,415,964 describes a project in this regard, which provides a system capable of automatically adjusting the voltage output regardless of the input voltage, modifying the organization of coils in an output transformer when changing the coils for configuration in parallel when turned on at 110V, thus causing an output of 110V; and, inversely, it changes the coils for configuration in series when turned on at 220V, thus repeating again an output of 110V. However, this way of control limits the measurement of all loads to a specific voltage and uses a transformer which, apart from limiting the loads to be switched on, generates extra energy consumption, even when the home appliance is not being used.

Other information considered state of the art includes North-American document U.S. Pat. No. 5,001,623, which describes an automatic voltage control system with a direct current output that, yet, has the same problems of the document abovementioned, and North-American document U.S. Pat. No. 7,528,734, which describes a system that indicates the input voltage, capable of informing the user whether the voltage in that specific location is the one expected for the devices to operate, but without change or control of the output voltage.

The solutions described in documents U.S. Pat. No. 5,001,623 and U.S. Pat. No. 7,528,734 are susceptible to transient events and other disruptions at the power lines and present high energy consumption and huge manufacture and maintenance costs if compared to the invention herein.

It is worth also highlighting that the controls of home appliances generally use a single voltage supply, usually a transformer that feeds all the devices of the home appliance. Thus, the transformer is measured at a specific voltage and all the devices are measured for performance at the transformer's voltage.

Home appliances generally use an electronic control system, which manages the activation of all devices of a set of electrical loads. Many of these devices are activated in relation to the activation of other devices;

for instance the activation of a blower which only happens when the compressor's motor is activated by a refrigerator. However, these devices may have different current levels, and activation in series or in the same circuit may influence the performance or even the burning of such devices.

Thus, the control system generally has several independent outlets for the control of devices, also for the activation of the devices which are simultaneously activated. This results in a measurement of more expensive and powerful processors, raising the final costs of the home appliance. It is important to further highlight that the electronic parts of control and of power supply often generate a big share in the costs of home appliances.

### Purposes of the Invention

Therefore, one goal of this invention is to provide a voltage control which uses the coils of an induction motor for feeding devices that are simultaneously switched to the motor, decreasing the costs of system control and reducing the measurement of the home appliances supply.

Furthermore, another purpose of this invention is to offer voltage control in which the energy provided to the devices totally comes from the network, with no principle of energy storage or regeneration which generate extra consumption of energy.

The present invention also aims at using an electric motor, already existent in home appliances, as a dual voltage supply of devices when using the combination of its coils as an input voltage divider. Finally, the last purpose of this invention is to provide a home appliance configured to use the method, system or motor according to the specified goals.

### SUMMARY OF THE INVENTION

One first embodiment of the invention shows a control system for home appliances, the system comprising at least one input voltage, one processing unit, one set of output switches, one set of electrical loads having an operating voltage and one electric motor having at least two coils. The processing unit is configured to detect the input voltage and to operate over the set of output switches to execute the activation of devices of the set of electrical loads and the activation of the electric motor, apart from being configured to adjust the input voltage detected by the processing unit to the operating voltage of the electrical loads by means of the voltage division in the coils of the electric motor.

The present invention describes a control system for home appliances, the system comprising at least one input voltage, one processing unit, one set of output switches, one set of electrical loads which have an operating voltage and one electric motor having at least two coils, in which the devices of the set of electrical loads are electrically coupled to one of the coils of the electric motor, using the coil as voltage supply for activation thereof.

In another embodiment, the invention presents a control method for home appliances which have a set of electrical loads which include at least one electric motor having at least two coils, comprising the steps of:

a. Detecting an input voltage;

b. Defining an operating voltage of devices of the set of electrical loads;

c. Adjusting the input voltage detected for the devices of the set of electrical loads; and

d. Working on the activation of devices of the set of electrical loads and on the activation of the electric motor, and adjusting the input voltage to the operating voltage of the electrical loads by means of the voltage division in the coils of the electric motor.

In this regard, the present invention also describes a control method for home appliances which have a set of electrical loads that include at least an electric motor having at least two coils, comprising the steps of:

a. Detecting an input voltage;

b. Defining an operating voltage of devices of the set of electrical loads;

c. Adjusting the input voltage detected for the devices of the set of electrical loads;

d. Coupling devices of the set of electrical loads to the outlet of a coil of the electric motor; and

e. Working so as to use one of the coils of the electric motor as voltage supply for the activation of these devices.

Additionally, the invention also presents the use of an electric motor having at least two coils for feeding devices of a set of electrical loads of a home appliance in which one of the coils of the electric motor is used as voltage supply for feeding the devices of the set of electrical loads.

Finally, the invention describes a home appliance which comprises a control system, a control method or the use of an electric motor for feeding according to the previous specifications.

### SUMMARIZED DESCRIPTION OF THE DRAWINGS

The present invention will be further described in more details based on one example of execution represented in the drawings. The figures show:

FIG. 1—is a representation of the motor of a compressor in which the coils are combined in series;

FIG. 2—is a representation of the motor of a compressor in which the coils are combined in parallel;

FIG. 3—is a block diagram that represents the simplified system according to the state of the art on home appliances;

FIG. 4—is a block diagram that represents the simplified system according to a preferred embodiment of this invention; and

FIG. 5—is a block diagram that represents the simplified system according to a second embodiment of this invention;

### DETAILED DESCRIPTION OF THE FIGURES

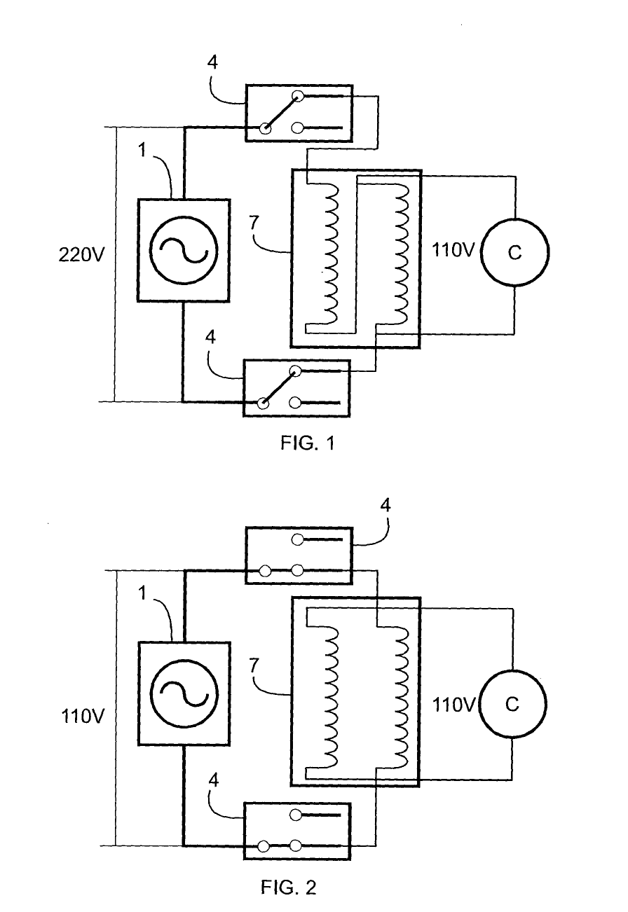

FIGS. 1 and 2 show electrical loads which have elements that can be organized so as to be selectively activated for operations at different voltages. In the invention herein, these loads are preferably electric motors having two or more coils, which generally correspond to the motor of a compressor 7 in refrigeration systems.

The motors of compressors 7 preferably used by this system are single-phase induction motors, which comprise at least one stator that has one or more gear windings and one or more start-up windings, in addition to preferably one cage rotor. These induction motors can also be of controlled variable speed, apart from other types not mentioned that can be built under the specified configurations, having one or more coils which can be combined in series or in parallel. The motors preferably used in this invention also have a T-configuration, comprising the construction of two main coils that can be organized in series or in parallel, and one startup auxiliary coil built in parallel to one of the main coils.

Therefore, FIG. 1 has a combination of the main coils of the electric motor in series. This way of combination is used when the input voltage 1 has a value twice the value of the operating voltage of the home appliance's devices, generally for input voltage 1 with value of 220V. It is worth highlighting that the input voltage 1 is divided into at least two of the coils of the electric motor, thus resulting in a voltage with value of the operating voltage of the devices in the outlet of one of the coils, normally 110V, that is, the nominal voltage of C loads. Thus, in one of the coils of the electric motor, C loads are coupled, and they use the coil as a voltage divider. Thus, a nominal operating voltage is delivered to the C loads once the operating voltage is delivered to the C loads by means of the voltage division among the coils of the electric motor.

Conversely, FIG. 2 shows a combination of the coils of the electric motor in parallel. This way of combination is used when the input voltage 1 has a value approximately equivalent to the value of the operating voltage of the home appliance' devices, generally for input voltage 1 with value of 110V. It is worth highlighting that, therefore, the input voltage 1 is the same in at least two of the coils of the electric motor, thus resulting in a voltage with value for the operating voltage of the devices in the outlet of one of the coils, normally 110V. Similarly to FIG. 1, in one of the coils of the electric motor, C loads are coupled, and they use the coil as a voltage divider. Thus, a constant operating voltage is delivered to the C loads regardless of the input voltage 1, that is, the input voltage 1 is applied to the load.

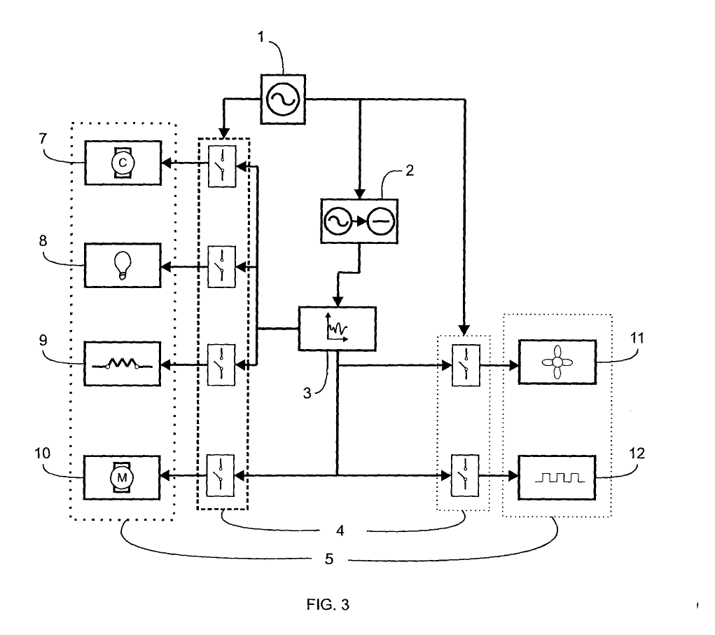

FIG. 3 illustrates a control method generally used by home appliance systems. In this regard, the control system comprises an input voltage 1, which feeds a direct current supply 2 capable of providing energy for the operation of a processing unit 3, which can also be a processing via analog circuit, for instance. Therefore, the processing unit 3 is capable of selectively working over the set of output switches 4, which preferably comprise electromechanical switches (such as relays or solenoids) or electronically controlled switches (such as static switches, TRIACs or transistors), mechanical ones or in solid state, also fed by the input voltage 1.

It is worth highlighting that, thus, the several devices of a set of electrical loads 5 of the home appliance, such as the compressor 7, the lamps 8, a set of resistances 9 which include freeze thaw resistance, other motors 10 of smaller scale for several applications such as motors for opening and closing doors or dampers, blowers 11 or other systems 12 such as timers or sensors, use the same input voltage supply 1 for activation thereof. Differently, the processing unit needs several specific outlets for each one of the output switches associated with the device to be activated.

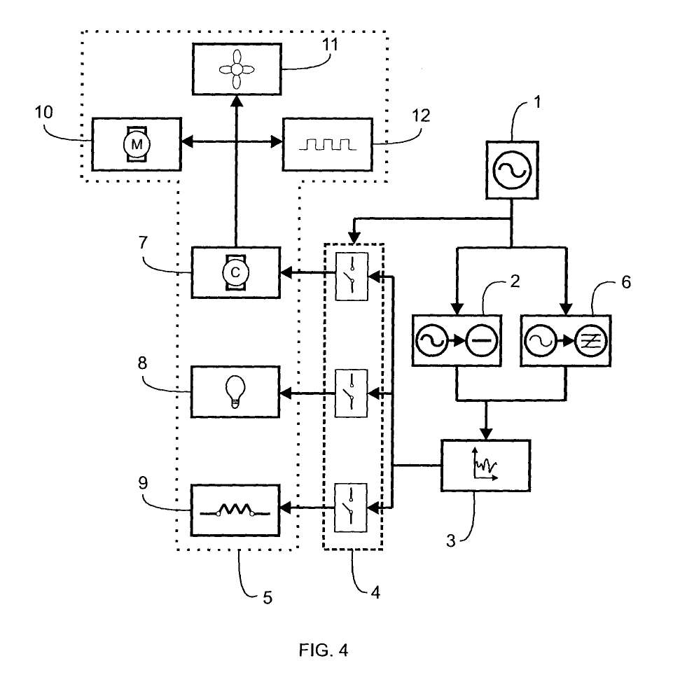

FIG. 4 presents the preferred control method of this invention, which comprises an input voltage 1, which feeds a direct current supply 2. The direct current supply 2 is capable of providing energy for the operation of the processing unit 3. The system is characterized by the direct or indirect detection of the input voltage 1. In the direct detection module, the processing unit 3 is configured to be directly connected to the input voltage 1, generally using an analog to digital conversion sensor. However, FIG. 4 illustrates an indirect detection module, once the input voltage 1 also feeds a network sensor 6, which detects the dimensions of this input voltage 1 and provides this information to the processing unit 3 for analysis; thus, the processing unit remains responsible for calculating and defining input voltage 1 values.

Additionally, the processing unit 3 is capable of selectively operating over the set of output switches 4, also fed by the input voltage 1. The set of output switches 4 is, thus, capable of operating so that the devices of the set of electrical loads 5 are organized more appropriately for the operation in the detected input voltage 1. The processing unit 3 is configured to detect the input voltage 1 and, if it detects that the input voltage has a value approximately double the operating voltage of the devices (generally 220V), it combines the coils in the motor of the compressor 7 in series. Conversely, if the detected voltage has a value worth approximately the operating voltage of the devices (generally 110V), it combines the coils of the motor of the compressor 7 in parallel.

This invention is particularly differentiated by the voltage control of the devices which are activated simultaneously with the compressor 7. Due to the control of the combination of coils, the voltage of any coil of the motor of the compressor 7 will always be approximately the value of the operating voltage of the devices. Therefore, the devices can be directly connected in parallel to one of the coils of the compressor 7, preferably in this invention by means of an hermetic terminal of five pins, which has two pins directly associated with one of the coils of the compressor 7. In this regard, examples of devices that may use this activation are blowers 11, sensors and timers, among others, which are activated during all the performance of the compressor and only during such activation.

It is worth highlighting that, thus, the processing unit 3 needs less outlets for the control of devices of the set of electrical loads 5, in addition to the possibility of a lower dimensioning of the input voltage supply 1 and of less output switches 4, reducing costs in the system.

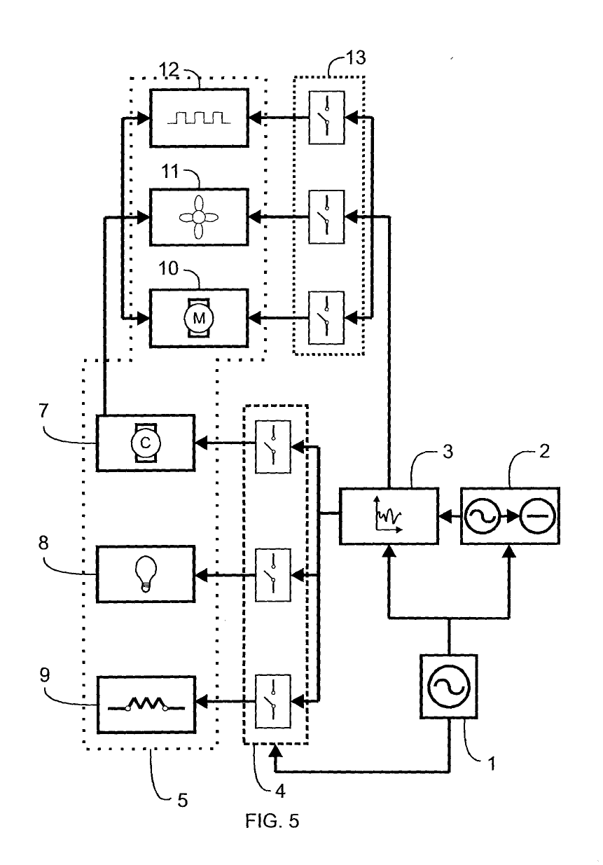

Likewise, FIG. 5 shows a second way of controlling the present invention, which comprises an input voltage 1, which feeds a direct current supply 2. The direct current supply is capable of providing energy for the operation of the processing unit 3. The system of FIG. 5 has a direct detection of the input voltage 1, once the processing unit is configured to be directly connected to the input voltage 1, having an extensive operation range (generally 90V to 260V), being responsible for the calculation and definition of input voltage 1 values.

The processing unit 3 is capable of selectively operating over the set of output switches 4, which is fed by the input voltage 1. The set of output switches 4 is, therefore, capable of operating so that the devices of the set of electrical loads 5 are organized in the most appropriate way for operation in the detected input voltage 1. Furthermore, the processing unit is capable of selectively operating over a second set of output switches 13. This second set of output switches 13 is not fed by the input voltage, but actually by one of the coils of the compressor 7 and, therefore, they can be dimensioned for voltages that are lower than the switches of the set of output switches 4. Therefore, the devices can be directly connected in parallel to one of the coils of the compressor 7 by means of the hermetic terminal, additionally having an output switch controlled by the processing unit 3 so that the activation is not directly related to the activation of the compressor 7. In this regard, examples of devices that use such activation include a damper or a motor 10 for the opening and closing of doors, once such devices must be activated when the compressor 7 is working, however not necessarily work during the entire activation of the compressor 7.

It is worth also highlighting that, as it can be seen in FIG. 5, the present invention can dimension stronger systems, such as lamps and resistances, for operation at double the voltage of more fragile devices. Thus, the processing unit 3 is configured to detect the input voltage 1 and, if it detects that the input voltage 1 has a value which is approximately the double of the operating voltage of the devices (generally 220V), it combines the coils of the motor of the compressor 7 in series and keeps a normal operating voltage for the devices connected to one of the coils of the compressor (generally 110V). If the detected voltage has a value which is approximately the operating voltage of the devices (generally 110V), the processing unit 3 combines the coils of the motor of the compressor 7 in parallel and keeps a normal operating voltage for the devices connected to one of the coils of the compressor (generally 110V), whereas the stronger systems specified for the double of this voltage, such as resistances and lamps, keep working, with lower efficiency.

Thus, the structure proposed in the control of this invention operates as an automatic voltage divider, which provides the devices with an efficient operating voltage with little variation, being used for dual voltage systems (normally 90-127V and 220-260V). The energy provided to the load totally comes from the network through the input voltage 1, having no principle of storage or regeneration of energy that generate extra energy consumption, such as the transformers used in state of the art documents. The association of a conventional load (single-phase AC) with one of the coils of the compressor has the sole purpose of adjusting the level of the devices' operating voltage, being generally the entire value or half the value of the input voltage 1, thus making it possible the application thereof to dual voltage systems.

However, it is important to highlight that the devices that use one of the coils of the compressor 7 as voltage supply must be dimensioned so as to not influence the voltage and current of the compressor 7, once they may cause failures in control or even the rotor to lock due to the loss of torque. Therefore, the devices cannot have high power in comparison to the coils of the compressor, once the currents would be increased to the extent of impairing the compressor's performance.

The present invention is generally applied to refrigerators, freezers, air-conditioners, washing machines, among others.

After describing an example of preferred embodiments, it shall be understood that the scope of the present invention encompasses other possible variations, being limited only by the contents of the attached claims, where the possible equivalents are included.

1-28. (canceled)

29. Control system for home appliances, the system comprising:
an input voltage (1);
a processing unit (3);
a set of output switches (4);
a set of electrical loads (5) which have an operating voltage; and
an electric motor having at least two coils;
wherein:
the processing unit (3) is configured to detect the input voltage (1) and selectively operate over the set of output switches (4) to perform the activation of devices of the set of electrical loads (5) and the activation of the electric motor; the processing unit (3) being configured to adjust the input voltage (1) detected by the processing unit (3) to the operating voltage of the devices of the set of electrical loads (5) by means of the voltage division in the coils of the electric motor; and
at least one of the devices of the set of electrical loads (5) are electrically coupled to one of the coils of the electric motor, using the coil as a voltage supply.

30. Control system for home appliances according to claim 29, wherein the processing unit (3) combines the coils of the electric motor in series when the detected input voltage (1) is approximately twice the value of the devices' operating voltage and in parallel when the detected input voltage (1) is approximately the value of the devices' operating voltage.

31. Control system for home appliances according to claim 29, wherein the processing unit (3) combines the coils of the electric motor in series when the detected input voltage is approximately 220V and in parallel when the detected input voltage (1) is approximately 110V.

32. Control system for home appliances according to claim 29, wherein the processing unit (3) is configured so as to operate with an input voltage ranging from 90V to 260V.

33. Control system for home appliances according to claim 29, wherein the processing unit (3) operates over the set of output switches (4) to adjust the input voltage (1) to an operating voltage from 90V to 127V in each one of the devices of the set of electrical loads (5).

34. Control system for home appliances according to claim 29, wherein the processing unit is configured to selectively operate over a second set of output switches (13).

35. Control system for home appliances according to claim 34, wherein the second set of output switches (13) are controlled by the processing unit (3).

36. Control system for home appliances according to claim 29, wherein the electric motor comprises an electric motor of a hermetic compressor.

37. Control method for home appliances that have a set of electrical loads (5) which include at least one electric motor having at least two coils, comprising the steps of:
a. detecting an input voltage (1);
b. defining an operating voltage of devices of the set of electrical loads (5);
c. adjusting the detected input voltage (1) for the devices of the set of electrical loads (5); and
d. operating in the selectively activation of devices of the set of electrical loads (5) and in the activation of the electric motor, and adjusting the input voltage (1) to the operating voltage of the devices of electrical loads (5) by means of the voltage division in the coils of the electric motor.
e. coupling at least one device of the set of electrical loads (5) to a coil of the electric motor; and
f. operating so as to use one of the coils of the electric motor as a voltage supply for the activation of these devices.

38. Control method for home appliances according to claim 37, wherein the step of operating in the selectively activation of the devices combines the coils of the electric motor in series when the detected input voltage (1) is approximately twice the value of the operating voltage of the devices and in parallel when the detected input voltage (1) is approximately the value of the devices' operating voltage.

39. Control method for home appliances according to claim 37, wherein the step of operating in the selectively activation of the devices combines the coils of the electric motor in series when the detected input voltage (1) is approximately 220V and in parallel when the detected input voltage (1) is approximately 110V.

40. Control method for home appliances according to claim 38, wherein the step of operating in the selectively activation of the devices operates in an input voltage (1) ranging from 90V to 260 V.

41. Control method for home appliances according to claim 38, wherein the step of operating in the selectively activation of the devices operates to adjust the input voltage (1) to an operating voltage from 90V to 127V in each one of the devices of the set of electrical loads (5).

42. Control method for home appliances according to claim 37, wherein the processing unit (3) selectively operates over a second set of output switches (13).

43. Control method for home appliances according to claim 37, wherein the electric motor comprises an electric motor of a hermetic compressor.

44. Use of electric motor of a hermetic compressor, the electric motor comprising at least two coils for feeding devices of a set of electrical loads (5) of a home appliance wherein one of the coils of the electric motor is used as voltage supply for feeding the devices of the set of electrical loads (5) and also is used to connect a second set of output switches (13).

45. Use of electric motor of a hermetic compressor according to claim 44, which home appliance comprises an input voltage (1) and one means for detecting the input voltage (1), wherein the coils of the electric motor are combined in series when the detected input voltage (1) is approximately twice the value of the devices' operating voltage and are combined in parallel when the detected input voltage (1) is approximately the value of the devices' operating voltage.

46. Use of electric motor of a hermetic compressor according to claim 44, which home appliance comprises an input voltage (1) and one means for detecting the input voltage (1), wherein the coils of the electric motor are combined in series when the detected input voltage (1) is approximately 220V and are combined in parallel when the detected input voltage (1) is approximately 110V.

47. Use of electric motor of a hermetic compressor according to claim 45, wherein it operates in an input voltage (1) ranging from 90V to 260V.

48. Use of electric motor of a hermetic compressor according to claim 45, wherein it operates to adjust the input voltage (1) to an operating voltage from 90V to 127V in each one of the devices of the set of electrical loads (5).
